(19) United States
(12) Patent Application Publication
(10) Pub. No.: US 2002/0164407 A1
(43) Pub. Date: Nov. 7, 2002

(54) Method for cleaning, packing and transporting vegetables

(76) Inventors: Steven K. Wolfe, Truckee, CA (US); Michael Tani, Santa Maria, CA (US)

Correspondence Address: Jeffrey A. Hall, 212 Clinton Street, Santa Cruz, CA, 95062, US

(21) Appl. No.: 10/188,204

(22) Filed: Jul. 1, 2002

Related U.S. Application Data
(63) Continuation-in-part of application No. 09/714,559, filed on Nov. 15, 2000.
Application No. 09/714,559 is a continuation-in-part of application No. 09/391,138, filed on Sep. 7, 1999, now abandoned.
Application No. 09/391,138 is a continuation-in-part of application No. 08/973,810, filed on Dec. 10, 1997, now abandoned.
Application No. 08/973,810 is a 371 of international application No. PCT/US96/03237, filed on Mar. 8, 1996.
Application No. PCT/US96/03237 is a continuation-in-part of application No. 08/501,415, filed on Jul. 11, 1995, now abandoned.

(51) Int. Cl. A23B 4/00

(52) U.S. Cl. 426/393

(57) ABSTRACT

A method for processing headed varieties of vegetables such as iceberg lettuce so as to remove all dirt, insects, and other debris from the vegetable and to allow shipping and transport of the vegetable while preserving the characteristics and versatility of the vegetable in a fresh form. The method comprises harvesting (10) the vegetable at or near maturity and then coring the vegetable (12). Latex is removed from cut surfaces (13) and a solubilized edible coating may be applied (14). A plurality of cored and separated leaves are made by separation of the leaves using a flow of water (15). The cored and separated leaves are then washed multiple times with each successive wash done using successively reduced water temperature (16). The plurality of separated leaves are maintained in a cool environment, preferably from 32 to 45 degrees F. The separated leaves are then packaged (22) in a permeable film or membrane sealed container allowing for the interchange of atmospheric gasses and gasses from the interior of the film or container, and stored (24) at a temperature which is equal to or less than the lowest temperature achieved in the preceding steps.

### CROSS-REFERENCE TO RELATED APPLICATIONS

This application is a continuation-in-part of and claims priority from co-pending U.S. patent application Ser. No. 09/714,559, filed Nov. 15, 2000 which is a continuation-in-part of U.S. patent application Ser. No. 09/391,138 filed Sep. 7, 1999 which is a continuation-in-part of Ser. No. 08/973,810, filed Dec. 10, 1997, which is a national stage filing under 35 U.S.C. 371 of PCT/U.S.96/03237, which is a continuation-in-part of U.S. patent application Ser. No. 08/501,415 filed Jul. 11, 1995.

### TECHNICAL FIELD

This invention relates to methods for packing, storing, and transporting vegetables headed varieties of vegetables, and particularly to methods for packing, storing, preserving, and transporting headed vegetables such as iceberg lettuce.

### BACKGROUND ART

Various methods and apparatuses have been proposed and implemented to effect the packing, storing, and transport of headed varieties of vegetables. Since the advent of commercially successful modified atmosphere packages for leafy greens in the later 1970's, the domestic market for fresh-cut packaged produce has exploded to a billion dollar per year industry. The convenience of prepared leafy salad products has been firmly established and all indicators point to further growth. Prior to the present invention, however, it has been only possible to provide tightly headed varieties of salad vegetables such as iceberg lettuce in chopped or shredded form. But larger pieces, such as separated leaves, areparticularly desirable for entree garnish and salad cups, and also in preparation of the larger pieces preferred for sandwich and hamburger caps. In the case of iceberg lettuce, the trade currently provides food service users with sectioned heads, with approximately 25% to 50% of the core end removed in a transverse slice. These sectioned heads are generally washed on a conveyor belt with overhead spray jets. Proper sanitation and consumer protection would dictate thorough cleansing all surfaces of such products. The present invention enables the introduction of the desired single leaf pieces in a convenient packaged format, with the leaves being cleansed in singular form to achieve sanitation requirements, and having undergone inspection to eliminate defects. The result is a product with superior utility, which also provides consumers with safe and valuable alternatives to currently available produce.

The export market has, for many years, also been an attractive one for growers and shippers of fresh fruits and vegetables. However, due to phytosanitary requirements to gain access to certain foreign markets, for example, Japan, exports have often been limited in both type and amount of produce exported. A particular concern in the produce export arena is that many unprocessed whole fruits and vegetables are prone to insect infestation, such as aphids, which subject the produce to rejection at the port of entry. The presence of one live aphid in a load of one thousand cartons (which can be comprised of from 24,000 to 38,000 heads of lettuce, for example) can cause the rejection of the entire load with accompanying economic loss. Nevertheless, demand for lettuce among Japanese and other consumers is high and growing.

For some time, a limited amount of fumigated lettuce product has been successfully exported to Japan, as well as washed, precut products such as chopped and shredded lettuce. However, the preference is for the whole forms and the flexibility in preparation it allows in providing larger pieces for a variety of uses. This leads to poorly controlled processing of intact heads on site by food service kitchen staff frequently distracted by a variety of other tasks, often leading to poor sanitation control. Heretofore, while methods have been developed for the preparation of unheaded forms of leafy green vegetables such as romaine and green leaf lettuces, they are not satisfactory for a tightly heading vegetable such as iceberg lettuce. And while fourteen to seventeen days of shelf-life are routinely achieved in the commercial packaging of cut and processed fresh iceberg lettuce, additional shelf-life is necessary for competitive and economical shipment to distant markets. The present invention allows for the fulfillment of a significant demand through the versatility offered by greatly extending shelf-life and also enabling the shipping of the leaves separated from the whole head of these much desired lettuce varieties.

The reason why the seemingly simple process of packaging and distribution of fresh vegetables has been difficult is that there are in fact significant technical obstacles which prior methods have failed to solve. After harvest, fresh fruit and vegetables continue to be living respiring material. As with the plant under the growing process, this post-harvest material remains subject to stress. Stress can be induced by heat, cold, insect attack, mechanical injury and myriad other conditions. When a living organism undergoes stress there is a response generated. In the case of plant tissue one common response to stress is the generation of volatile hormones, including ethylene. It has only been recently established by researchers in plant genetics, physiology, and cell biology, that ethylene and other volatile components can transmit signals to internally to remote parts of the plant tissue, and even to nearby, but separated tissue, generating a stress response. It has been found that stress response is mediated by several small proteins responsible for the activity of the volatile components. The readily observable and deleterious response from the standpoint of storage and shelf-life is an increase in plant respiration as it attempts to rally its defense systems against the real or perceived physiological or mechanical stress. Alone and in concert, stress responses in a plant can reduce its available shelf-life from weeks to merely hours.

For processed and packaged fresh product, shelf-life, as a term of the art, is a useful measure of the quality of the product that can be expected subsequent to production. Shelf-life denotes the time elapsing from processing over which the product decays to reach the lower limit of quality acceptable by the end user. Shelf-life is dependent on initial quality and processing method, but is also affected by care and handling subsequent to processing. However, the shelf-life available at completion of processing cannot be increased by any extraordinary methods of subsequent care and handling. The essence of shelf-life as a metric is that during the decay process, the decline in quality is continuous and, under comparable conditions, the product which initially had the longer shelf-life available will always exhibit greater quality at any point in time than the product that initially had lesser shelf-life available. To maximize available shelf-life requires maximum quality at completion of processing combined with proper packaging. The present invention describes a method incorporating sequential steps in handling that minimize physiological stress to plant issue and maximizes available shelf-life.

It is common in the art to reduce temperature as a means of inhibiting respiration rates in plant tissue, and thereby seek to extend shelf-life, but when the plant is allowed to undergo temperature fluctuations after this initial cooling, as commonly occurs during handling or processing, the resulting development of stress can counteract the intended result. A function of the present method is coordinating post-harvest activities leading to the finished product so that stress as a result of temperature fluctuation is eliminated. The temperature of the finished product, of itself, is not an indication of available shelf-life.

Post harvest respiration involves the metabolic conversion of oxygen to carbon dioxide by the produce and frequently, a concomitant release of ethylene. Ethylene is a plant hormone which usually enhances metabolic rate and is used commercially for accelerating the ripening of several crops, for example, bananas and tomatoes. Ferro, et al., U.S. Pat. No. 5,589,623, issued Dec. 31, 1996, discuss the benefit of transgenic control of ethylene generation by plant tissue to aid in preservation and improve shelf-life.

In addition, stress-induced excesses of ethylene in headed green vegetables can cause rapid senescence and spotting which is undesirable. Excess oxygen can cause deleterious oxidative processes to occur that the harvested plant is not capable of combating. For example, phenol oxidase-catalyzed reactions can lead to “pinking” of the white rib tissue in iceberg lettuce and to similar darkening and discoloration of cut and/or injured tissue. Carbon dioxide is also a significant problem for it is continually produced throughout the senescence of the plant and packaging of the produce allows for a buildup of carbon dioxide within the packaging or the container which may result in significant discoloration.

Further, in a closed environment, consumption of oxygen and production of carbon dioxide can rapidly progress to the stage where oxygen is less than one percent. Near, and below this point, respiratory processes traverse a different reaction pathway, namely via anaerobic processes. Such anaerobic processes result in partial oxygenated decay products such as aldehydes and ketones which may cause off flavors and aromas in the produce. Anaerobic conditions may also result in the growth of harmful anaerobic microbiological organisms.

All of the aforementioned factors are influenced by temperature, with deleterious results occurring more rapidly at higher temperatures. Moreover, the requirement for sanitation, temperature control, and effective processing techniques which minimize tissue damage and packaging technology that will allow for sanitary packaging while allowing the proper flow of atmospheric and respiratory gases, creates a complex system with varying specific requirements depending upon the particular fruit or vegetable being handled and the end user requirements.

Although a large variety of packing, storing, and transport methods have been developed for agricultural products, there exist significant shelf-life problems and economic limitations with all such methods, and particularly when applied to the shipping and handling of processed forms of headed varieties of vegetables such as lettuce. This has undoubtedly been a reason for the significant restrictions and problems limiting the export of such produce.

The objective of this method of this invention is to provide a unique and versatile product of superior quality with extended shelf-life by procedures that reduce stress to the plant material, including the selection of harvest maturity, harvest methods and transport, receiving and storing prior to processing, and in the multiple steps of the processing and cooling of the product.

Hougham, U.S. Pat. No. 5,316,778, issued May 31, 1994, teaches a method to reduce cellular damage in processing leafy vegetables by peeling the leaves from the stem of the plant, but it does not teach a method that is effective when the morphology of the plant prohibits this process, nor does it teach of the cross-application of the methods generally applicable to physiological processes in reduction of stress and shock to the plant tissue that underlay many of the positive benefits of obtained by it in peeling the leaf from the plant.

U.S. Pat. No. 1,708,253 issued to Bell, Apr. 24, 1925, U.S. Pat. No. 2,666,711, issued to Crosset Sep. 20, 1951, and U.S. Pat. No. 4,168,597, issued to Cayton, Sep. 25, 1979, have taught the use of apparatus and cooled water in the movement and handling of the processed material. L. Bell U.S. Pat. No. 5,226,972, issued Jul. 13, 1993, has taught the use of cooled air in reducing temperature of subdivided produce.

Whiteman in U.S. Pat. No. 6,086,967, issued Jul. 11, 2000, Fischer in U.S. Pat. No. 5,523,136, issued Jun. 4, 1996 and Kuo U.S. Pat. No. 5,491,019, issued Feb. 13, 1996, and others, have taught the use of gas-selective membranes for packaging of fresh produce. All of these methods and teachings are widely used in the industry and are familiar to one versed in the art.

Many have taught the use of chlorine and disinfectants as adjuncts in wash waters, and this method has long been employed throughout the food processing industry to retard the growth rate of potential spoilage microorganisms. Chen in U.S. Pat. No. 5,925,395, issued Jul. 20, 1999, and Cayton U.S. Pat. No. 4,168,597 issued Sep. 25, 1979, have taught the use of preservatives in treating fresh produce. Busta and Brooks in U.S. Pat. No. 3,814,820, issued Jun. 4, 1974, discloses the use discoloration inhibitors and preservatives in processing fresh vegetables. The preferred method of the present invention does not rely on chemical adjuncts beyond the use of a sanitizing agent. The preferred sanitizing agent is a composed of a hypohalite such as hypochorite, chlorine gas in aqueous solution, ozone, or hydrogen peroxide, but other sanitizers may be used that are consistent with their intended application in edible food products. As an alternative to measurements of sanitizing effectiveness which rely on direct methods for the determination of concentration, measuring the oxidation-reduction potential, or ORP is a term of art in common use, to among other uses, judge the relative effectiveness of a solution in destroying microorganisms. The more positive the ORP of a solution the more effective is its oxidizing power in killing microorganisms. Various commercial instruments are available to determine ORP.

Nussinovitch in U.S. Pat. No. 6,299,915, issued Oct. 9, 2001 and Yang in U.S. Pat. No. 6,203,833, issued Mar. 20, 2001, teach methods for coating the exterior surface of fresh vegetables. In the present invention, additional extension of shelf-life may be obtained with the incorporation of edible coatings to protect freshly cut surfaces.

Accordingly, it is the primary object of this invention to provide a method of cleaning, processing, packing, and transporting headed varieties of vegetables which emphasizes reduction in plant stress at each point in the processing sequence, as illustrated in FIG. 1, and which thereby allows such vegetables to be harvested, cleaned, packaged, and shipped in a washed separated leaf format which is independent of preservatives and maintains the critical and important characteristics of such headed vegetables while guaranteeing them to be free of insects or other infestation and debris, which is inexpensive to apply, which achieves remarkable shelf-life extension, is highly efficient in result, and which provides a unique product with extended shelf-life to meet the needs of food service, retailers and consumers, and export markets.

The preferred method is presented wherein stress from temperature variations and mechanical damage is minimized in order to minimize acceleration of the respiration rate of the plant material, and its consequent acceleration of decay, in the handling and processing of certain heading varieties of leafy vegetables, such as lettuce, cabbage, radicchio and morphologically similar crops. Since these varieties require that the core be removed in processing, which creates a situation of stress to the tissue, the observation of the preferred method in the prior and subsequent steps in processing is essential in maximizing available shelf-life. It is known to one familiar with the art that the processing steps must be handled in ways that are timely and expeditious. And it is known to one familiar with the art that the temperature reduction is an adjunct to extension of shelf-life. The present method employs controls in the stepwise reduction of temperature and minimization of mechanical injury that greatly increase the available shelf-life of a product that has not heretofore been available. The use of edible coating materials may be used on the cut surfaces to reduce the effect of wound injury at that site. Within the normal time of processing, the temperature of the individual steps is not the controlling element of success, rather it is the elimination of increases in temperature and gentleness in handling the raw material and separated leaves throughout the process that result in minimal stress and contribute to its success in providing products of separated leaves with greatly extended available shelf-life. Moreover, these basic principles in stress reduction are applicable to extension of shelf-life in the care and processing of any fresh fruit or vegetable which may benefit from temperature reduction.

Additional objects and advantages of the invention will be set forth in the description which follows, and in part will be obvious from the description, or may be learned by practice of the invention. The objects and advantages of the invention may be realized and obtained by means of the methods and combinations particularly pointed out in the appended claims.

### DISCLOSURE OF INVENTION

The present invention provides a method for reducing stress to plant materials in the harvesting, cleaning, and packaging headed varieties of vegetables such as cabbage, iceberg lettuce, radicchio, and other morphologically similar produce, to yield separated leaves and thereby allowing for the thorough cleaning, packing, and transport of such leafy vegetables while preserving many of the critical and desired characteristics and guaranteeing that such produce be free of insects or other infestations and debris.

To achieve the foregoing objects, and in accordance with the purpose of the invention as embodied and broadly described herein, a method for cleaning, processing, packing, and storing headed varieties of vegetables is provided, comprising: harvesting the headed leafy vegetable at or near maturity; removing the core from the leafy vegetable, latex removal from the cut surfaces, and then separating the leaves from remaining head of the leafy vegetable using a flow of water directed at the cored base of the head thereby elevating the relative pressure on the interstices of the leaves left upon removal of the core from the head to effect separation of the leaves from the remaining cored head. The separated leaves are then washed so as to remove dirt, insects, and other debris from the separated leaves. The separated leaves are then dried and cooled. The separated leaves are then packaged in a permeable or membrane sealed container allowing for an interchange of atmospheric and interior gases. A stepwise reduction in temperature between the aforementioned steps significantly reduces stress to the leafy tissues. Edible coatings may be employed after removal of the core from the leafy vegetable.

The method of the present invention is preferably used with headed leafy vegetables such as lettuce, including iceberg lettuce and other headed leafy vegetables wherein the leaves are closely formed, such as radicchio, and cabbage, and the like. In fact, the particular application is dependent only upon the requirements of the user as a wide range of headed vegetables could be cleaned, packaged, and transported using the methodology described herein.

In accordance with the present invention there also is provided an improved method of cleaning, processing, packaging, and storing iceberg lettuce to effectuate the process, comprising: harvesting said lettuce at or near maturity; coring the lettuce; separating the leaves from the core material; latex removal from cut surfaces; washing the separated leaves; drying the separated leaves; cooling the separated leaves; and packaging the separated leaves in a permeable film or membrane sealed container allowing for the interchange of atmospheric and interior gases. The methodology provides for a controlled stepwise lowering of temperature in each step of the process, thereby reducing stress and damage to vegetative tissue

### BRIEF DESCRIPTION OF DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIGS. 1A and 1B is a flow chart of the method for cleaning, packing, and transporting headed vegetables varieties, according to the invention.

### BEST MODE FOR CARRYING OUT THE INVENTION

Reference will now be made in detail to the present preferred embodiments of the invention as illustrated in the accompanying drawings.

In accordance with the present invention, there is provided a unified method for reducing plant stress in cleaning, processing, packing, and storing of separated leaves of headed varieties of vegetables, comprising: harvesting the headed leafy vegetable at or near maturity; coring the leafy vegetable: removing latex form cut tissues; separating the leaves from the cored head of the leafy vegetable using a flow of water, preferably under moderate pressure; washing said separated leaves so as to remove dirt, insects, and other debris off the separated leaves, with preferably the multiple washing being used with each successive washing done at a increasingly reduced water temperature; drying said separated leaves; cooling said separated leaves; and packaging said separated leaves in a permeable or membrane sealed container allowing for an interchange of atmospheric and interior gasses.

There is also provided, in accordance with the invention a method of reducing plant stress in cleaning, processing, packaging, and storing lettuce, or Lactuca sativa, including varieties as iceberg lettuce, comprising: harvesting said lettuce at or near maturity; coring the lettuce; removing latex form cut tissues, separating the leaves from the cored lettuce using a flow of water; multiple washings of said separated leaves with each successive washing done with a reduction of water temperature; drying said separated leaves; cooling the separated leaves; and packaging the separated leaves in a permeable film or membrane sealed container allowing for the interchange of atmospheric and interior gases.

There is further provided, in accordance with the invention a method of reducing plant stress in cleaning, processing, packaging, and storing separated leaves of leafy vegetables wherein an edible coating is applied to the freshly cut surface after coring the leafy heading vegetable, separating the leaves from the cored vegetable lettuce using a flow of water; multiple washings of said separated leaves with each successive washing done with a reduction of water temperature; drying said separated leaves; cooling the separated leaves; and packaging the separated leaves in a permeable film or membrane sealed container allowing for the interchange of atmospheric and interior gases.

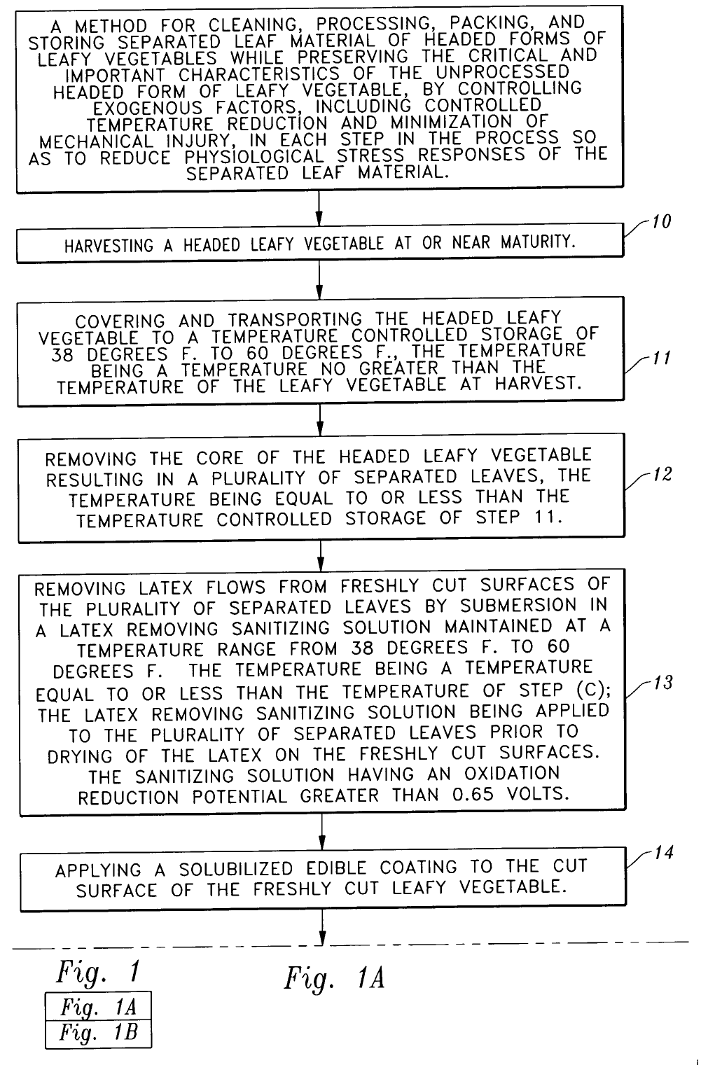

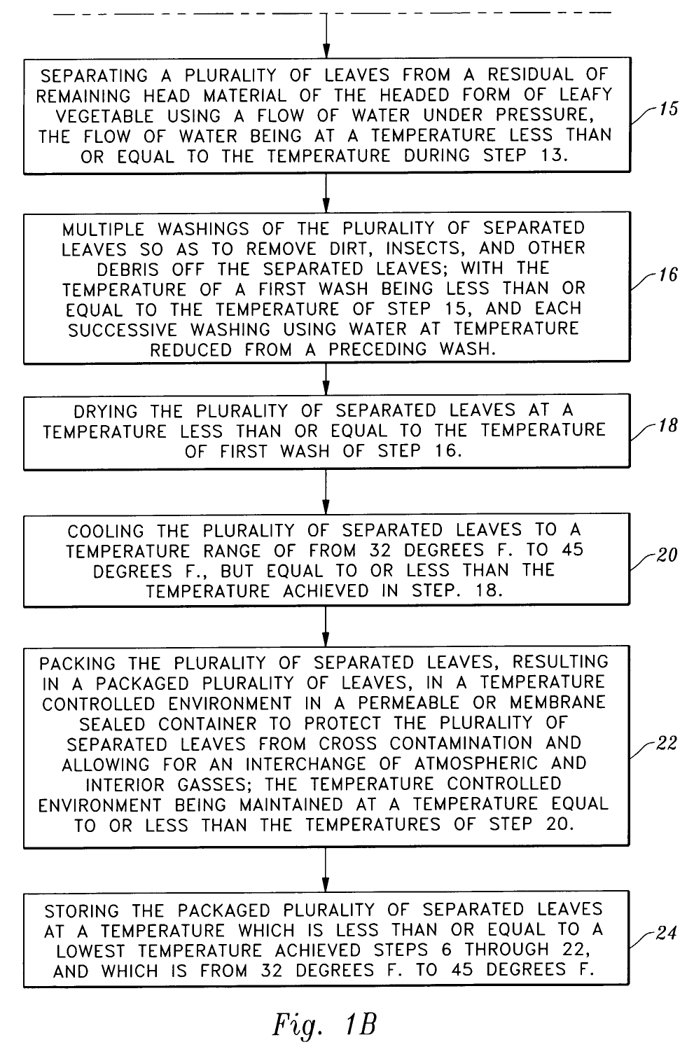

In FIG. 1, a flow diagram is shown outlining the steps the method of the present invention. In step 10, the lettuce or other produce is harvested at, or near maturity, preferably 5-7 days prior to commercial practice for harvest, when the leafy vegetable, such as iceberg lettuce, is somewhat more loosely formed in regard to internal structure which facilitates the separation of the leaves without mechanical damage to the leaves. The resulting loss in weight from the early harvest in compensated by the amount of useable and consumable product obtained and its commercial value. To minimize mechanical damage from crushing and bruising the lettuce or other produce be harvested into standard containers such as cartons, totes, or bins. The preferred method employs smaller re-usable totes or bins, such that the vegetable has a minimum of stacked weight above it. The harvested crop is preferably covered 11, to protect it from wind and sun and it is immediately moved to a cool storage environment in the range of 38 to 65 degrees F., preferably 45 to 55 degrees F.

As seen in step 12, the lettuce or other produce is then cored either manually or using mechanical means which may include mechanical cutters, corers, or the like. The method selected should ensure that the produce is not subjected to any mechanical damage other than the necessitated by removal of core or extraneous material. The preferred method is manual removal of the core with sharp stainless steel knives. After the removal of this material the produce is immediately submerged in a sanitizing solution with 10 to 200 parts per million of chlorine, preferable 20 to 50 parts per million of chlorine to water, and temperature of 38 to 55 degrees F. preferably 45 to 55 degrees F., and preferably of temperature such that it is 2 to 10 degrees F. cooler than that of the recently harvested product, with the freshly cored end submersed for latex removal 13, from the cut surfaces. Preferably, the oxidation-reduction potential, or ORP, of the sanitizing solution is maintained with an ORP greater than 650 millivolts or 0.65 volts. This washing step removes the latex that flows from the freshly cut surfaces before it can dry onto the freshly cut surfaces. Such dried latex material can be subsequently difficult to remove and can lead to discoloration of the cut surface.

The cut surfaces may be treated with an edible coating 14, that will act to inhibit oxidation and reduce respiration increases due to wound injury. The edible coatings may be polysacccharides, such as cellulose, modified cellulose, starch, agar, carageenan, alginate, pectin, and the like. Proteins such as zein, collagen, gelatin, ovalbumn, myofibrilllar proteins, and the like, may alternatively be used. Or lipids such as carnuba wax, bees wax, lauric acid, palmitic acid, stearic acid, or the like, may be applied as a coating or a film. The preferred form of edible coating is water-soluble, but it need not be for a spraying application, where an alcohol solvent or related spray could be employed. Any non-toxic substance that can dry, or almost dry, to provide a matrix coating which will prevent bacterial entry into the wound, inhibit oxidation reactions, seal the wound to prevent fluid and water vapor loss, may be used effectively.

There are three ways that edible coatings may be utilized; after the coring, the cut ends are sprayed with a solution of the active coating, then allowed to dry briefly before placement into the first solution (although it may dry quickly and no pause is necessary; after the coring, the lettuce or other headed leafy vegetable is placed into the first solution, with the cut end down as described, and the wash itself contains the dissolved active coating; or, the entire leaf is coated by having one or more of the washes contain the dissolved coating, preferably the last wash only, but at the least the last wash.

Next, as seen in step 15, the leaves are separated from the headed vegetable or other produce so as to permit the removal by washing of dirt, debris, insects and other infestations. Preferably the leaves are manually separated from the head under water, using a directed flow of water, with the water pressure enhanced by moderate pressure. The water flow may also incorporate elements of turbulence in the flow to facilitate the gentle separation of leaves from the head. In order to ensure the integrity of the separated leaves, it is essential to core the lettuce or other produce in order to produce a product which may be cleaned and inspected and which has all of the key characteristics of the vegetable or other produce while guaranteeing it to be free of insects or other infestation and debris.

The separated leaves are then washed with water as shown in step 16. Multiple washings preferably are used with each successive washing done using water at a temperature of 32 to 50 degrees F., but preferably such that each wash is reduces the temperature of the separated leaves relative to the result of the preceding wash by 2 to 10 degrees F. In one embodiment, two washings are used, a first wash and a second wash. In other embodiments three or more washings may be used. Each wash is preferably sanitized with chlorine or other disinfectants. If chlorine is used, solutions ranging from 5 to 200 parts per million of chlorine may be used, with concentrations of chlorine being in the range of 20 to 100 parts per million to water preferred. The washing steps remove dirt, debris, insects and other infestations form the leaves. In step 20, it is seen that the separated leaves are cooled. However, cooling may occur prior to any of the aforementioned steps, and can be augmented by the selection of temperatures for each rinsing solution, the only criterion being protection of the delicate separated leaves that are subject to increased turgidity and rupture when handled excessively at reduced temperatures, and that the subsequent steps do not allow an elevation in temperature. The leaves may be sorted for size, color or other characteristic at any point in the method.

The separated leaves are then packaged 22, in a permeable film or membrane-sealed container that will allow sufficient, but not excessive, interchange of atmospheric and interior gases. The films may be high density, mid-density, or low density breathable polyethylene for example, or other non-surface adhering thermoplastics may be utilized such as linear low density polyethylene, polypropylene, polystyrene, biaxially oriented polypropylene, vinyl acetate copolymers, polyvinyl chloride, mixtures or the foregoing, multi-layer films of the foregoing, and other polymers and copolymers. A critical characteristic of any film or membrane used is that it permits the sufficient but not excessive interchange of atmospheric and interior gases. These films and membranes are well known in the trade and widely available to meet particular conditions.

The packaged leaves are then stored 24, at a temperature between 32 and 45 degrees F., and which is preferably less than or equal to the lowest temperature achieved in steps 11 to 22.

In the preferred method, proper cooling and subsequent temperature control are maintained from initial onset of cooling throughout the distribution chain of the produce. In most cases, the temperature range of the packaged product will be from about 32-45 degrees F., preferably in the range of 32 to 38 degrees F.

Cooling in processing may be effected by any of a number of means well known in the art such as vacuum cooling or exposing the produce to cool air. Alternatively, hydro-cooling using chilled water may also be effective, and may be implemented in the washing step 16 if desired. However it may be done, the preferred method involves continuous reduction in temperature without high and low temperature fluctuations to achieve the maximum benefits obtainable by reducing the physiological and mechanical stress on the plant tissue caused by temperature fluctuations and injury and thereby reducing respiratory response and extending usable shelf-life of the separated product to in excess of 24 days.

In operation and use the method of the present invention is highly efficient, cost effective, and easy to implement. The method of the present invention may be implemented in a produce room, packing house, or any other suitable building or location. Alternatively, the method of the present invention may be effected on a portable harvesting machine that operates directly in the field. The method of the present invention as herein described may be used with any headed variety of vegetable, however, it is most conveniently used with vegetables such as lettuce, particularly head lettuce such as iceberg lettuce thereby allowing for the year-round supply of fresh supply of produce to both domestic and international consumers with all of the key and critical characteristics preserved while guaranteeing the produce to be free of insects or other infestations, dirt, and debris.

Additional advantages and modification will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

1. A method for cleaning, processing, packing, and storing separated leaf material of headed forms of leafy vegetables while preserving the critical and important characteristics of the unprocessed headed form of leafy vegetable, by controlling exogenous factors, including controlled temperature reduction and minimization of mechanical injury, in each step in the process so as to reduce physiological stress responses of the separated leaf material; comprising:
(a) harvesting a headed leafy vegetable at or near maturity;
(b) transporting said headed leafy vegetable to a temperature controlled storage of 38 degrees F. to 60 degrees F., said temperature being a temperature no greater than the temperature of the leafy vegetable at harvest;
(c) removing a core of the headed leafy vegetable resulting in a plurality of separated leaves, said temperature being equal to or less than said temperature controlled storage of step (b);
(d) removing latex flows from freshly cut surfaces of the plurality of separated leaves by submersion in a latex removing sanitizing solution maintained at a temperature range from 38 degrees F. to 60 degrees F., said temperature being temperature equal to or less than said temperature of step (c); said latex removing sanitizing solution being applied to the plurality of separated leaves prior to drying of said latex on the freshly cut surfaces;
(e) separating said plurality of leaves from a residual of remaining head material of the headed form of leafy vegetable using a flow of water under pressure, said flow of water being at a temperature less than or equal to said temperature during step (d);
(f) washings two or more times said plurality of separated leaves so as to remove dirt, insects, and other debris off the separated leaves; with the temperature of a first wash being less than or equal to the temperature of step (e), and each successive washing using water at temperature reduced from a preceding wash;
(g) drying said plurality of separated leaves at a temperature less than or equal to the temperature of said first wash of step (f);
(h) cooling said plurality of separated leaves to a temperature range of from 32 degrees F. to 45 degrees F., but equal to or less than said temperature achieved in step (g);
(i) packaging said plurality of separated leaves, resulting in a packaged plurality of leaves, in a temperature controlled environment in a permeable or membrane sealed container to protect the plurality of separated leaves from cross contamination and allowing for an interchange of atmospheric and interior gasses; said temperature controlled environment being maintained at a temperature equal to or less than said temperature of step (h); and
(j) storing said packaged plurality of separated leaves at a temperature which is less than or equal to a lowest temperature achieved in steps (b) through (i), and which is from 32 degrees F. to 45 degrees F.

2. The method of claim 1, wherein said headed form of leafy vegetable is iceberg lettuce.

3. The method of claim 1, wherein said headed form of leafy vegetable is radicchio.

4. The method of claim 1, wherein said headed form of leafy vegetable is cabbage.

5. The method of claim 1, wherein said separating of said plurality of separated leaves from said headed form of leafy vegetable is achieved by manual methods.

6. The method of claim 1, wherein said separating of said plurality of leaves from said headed form of leafy vegetable is achieved by mechanical methods.

7. The method of claim 1, wherein said packaging of said plurality of separated leaves comprises packaging a single head equivalent of a headed form of leafy vegetable in a single package.

8. The method of claim 1, wherein prior to step (c) said headed leafy vegetable is maintained at a temperature of from 38 degrees F. to 60 degrees F.

9. A method for cleaning, processing, packing, and storing separated leaf material of headed forms of leafy vegetables while preserving the critical and important characteristics of the unprocessed headed form of leafy vegetable, by controlling exogenous factors, including controlled temperature reduction and minimization of mechanical injury, in each step in the process so as to reduce physiological stress responses of the separated leaf material; comprising:
(a) harvesting a headed leafy vegetable at or near maturity;
(b) transporting said headed leafy vegetable to a temperature controlled storage of 38 degrees F. to 60 degrees F., said temperature being a temperature no greater than the temperature of the leafy vegetable at harvest;
(c) removing a core of the headed leafy vegetable resulting in a plurality of separated leaves, said temperature being equal to or less than said temperature controlled storage of step (b);
(d) removing latex flows from freshly cut surfaces of the plurality of separated leaves by submersion in a latex removing sanitizing solution maintained at a temperature range from 38 degrees F. to 60 degrees F., said temperature being a temperature equal to or less than said temperature of step (c); said latex removing sanitizing solution being applied to the plurality of separated leaves prior to drying of said latex on the freshly cut surfaces; said latex removing sanitizing solution having an oxidation-reduction potential greater than 0.65 volts;
(e) applying a solubilized edible coating to the cut surface of the freshly cut leafy vegetable,
(f) separating a plurality of leaves from a residual of remaining head material of the headed form of leafy vegetable using a flow of water under pressure, said flow of water being at a temperature less than or equal to said temperature during step (d);
(g) multiple washings of said plurality of separated leaves so as to remove dirt, insects, and other debris off the separated leaves; with the temperature of a first wash being less than or equal to the temperature of step (f), and each successive washing using water at temperature reduced from a preceding wash;
(h) drying said plurality of separated leaves at a temperature less than or equal to the temperature of said first wash of step (g);
(i) cooling said plurality of separated leaves to a temperature range of from 32 degrees F. to 45 degrees F., but equal to or less than said temperature achieved in step (h);
(k) packaging said plurality of separated leaves, resulting in a packaged plurality of leaves, in a temperature controlled environment in a permeable or membrane sealed container to protect the plurality of separated leaves from cross contamination and allowing for an interchange of atmospheric and interior gasses; said temperature controlled environment being maintained at a temperature equal to or less than said temperature of step (i); and
(l) storing said packaged plurality of separated leaves at a temperature which is less than or equal to a lowest temperature achieved in steps (b) through (k), and which is from 32 degrees F. to 45 degrees F.

10. The method of claim 9, wherein said headed form of leafy vegetable is iceberg lettuce.

11. The method of claim 9, wherein said headed form of leafy vegetable is radicchio.

12. The method of claim 9, wherein said headed form of leafy vegetable is cabbage.

13. A method for reducing stress and damage to lettuce leaves during cleaning, processing, packing, and storing of the lettuce leaves, while preserving all of the critical and important characteristics of such lettuce leaves, comprising:
harvesting the lettuce at or near maturity;
covering the harvested lettuce and storing the harvested lettuce at a temperature of from 38 degrees F. to 60 degrees F.;
coring the lettuce, resulting in a plurality of separated leaves:
removing latex flows from freshly cut surfaces of the plurality of separated leaves by submersion in a latex removing sanitizing solution maintained at a temperature range from 38 to 60 degrees F.; said latex removing sanitizing solution being applied to the plurality of separated leaves prior to drying of said latex on the freshly cut surfaces;
separating said plurality of cored and separated leaves from the lettuce using a directed flow of water under pressure;
a first washing and a second washing of said plurality of separated leaves in water in a temperature range of from 32 to 50 degrees F. so as to remove dirt, insects, and other debris off the separated leaves; said second wash using water at temperature reduced from said first wash in a temperature range of from 5 to 10 degrees F. lower in temperature;
drying said plurality of separated leaves;
cooling said plurality of separated leaves; and
packaging said plurality of separated leaves in a permeable or membrane sealed container allowing for an interchange of atmospheric and interior gasses.

14. The method of claim 13, wherein said lettuce is iceberg lettuce.

15. The method of claim 13, wherein said lettuce is raddichio lettuce.

16. The method of claim 13, wherein said latex removing sanitizing solution contains chlorine in a concentration from 20 to 50 parts per million chlorine to water. The method of claim 12, wherein said latex removing sanitizing solution has an oxidation-reduction potential greater than 0.65 volts.
